(19) United States
(12) Patent Application Publication
(10) Pub. No.: US 2025/0259411 A1
(43) Pub. Date: Aug. 14, 2025

(54) METHOD AND SYSTEM FOR SENSING AN ENVIRONMENT OF A DEVICE USING SPARSE SPECTRA

(71) Applicant: Robert Bosch GmbH, Stuttgart (DE)

(72) Inventors: Kilian Rambach, Stuttgart (DE); Daniel Kenta Jenet, Stuttgart (DE); Maurice Quach, Ditzingen (DE); Maxim Tatarchenko, Berlin (DE); Oliver Kern, Renningen (DE); Sascha Braun, Eningen Unter Achalm (DE); Yuri Feldman, Haifa (IL)

(21) Appl. No.: 19/032,764

(22) Filed: Jan. 21, 2025

(30) Foreign Application Priority Data
Feb. 9, 2024 (DE) 10 2024 201 183.5

(51) Int. Cl. G06V 10/40; G01S 13/931; G01S 15/931; G01S 17/931; G06V 10/26; G06V 20/56

(52) U.S. Cl. CPC G06V 10/40; G01S 13/931; G01S 15/931; G01S 17/931; G06V 10/267; G06V 20/56

(57) ABSTRACT

A device, a system, and a method for sensing an environment of a device using sparse spectra. The method includes generating, with a sensor of the device, a time signal with information about features of an object or multiple objects in the environment of the device; determining dense spectra having N dimensions based on the time signal, wherein the time signal comprises information for generating dense spectra having K dimensions, wherein K is greater than or equal to N; determining sparse spectra having N dimensions based on the dense spectra having N dimensions, wherein the amount of data for representing the sparse spectra is less than the amount of data for representing the dense spectra having N dimensions, and determining first features of the one or more objects for one point or for multiple points in the sparse spectra.

### CROSS REFERENCE

The present application claims the benefit under 35 U.S.C. § 119 of German Patent Application No. DE 10 2024 201 183.5 filed on Feb. 9, 2024, which is expressly incorporated herein by reference in its entirety.

### FIELD

The present invention relates to a method and a system for sensing an environment of a device using sparse spectra, in particular for devices in the motor vehicle, aviation, marine, astronautics and/or manufacturing industries.

### BACKGROUND INFORMATION

Assistance systems for controlling or supporting control of a device, such as driver assistance systems or systems that make possible an autonomous control of, for example, a vehicle, an aircraft, or a ship, require precise information about the environment of the device to make possible a reliable and secure control of the device.

To sense information about the environment, electromagnetic radiation may be used at different frequency ranges, with different technologies for sensing the information, such as analog or digital photography, LIDAR technology (light detection and ranging, LIDAR), or RADAR technology (radio detection and ranging, RADAR). Alternatively or additionally, acoustic waves may also be used to sense information about the environment, using, for example, ultrasonic technology and/or SONAR (sound detection and ranging, SONAR) technology. Other technologies suitable for sensing an environment are also possible.

The sensors of the respective technology typically provide measurements, which are provided in the form of spectra or in the form of a dense point cloud. For example, RADAR sensors may provide a point cloud consisting of the detected RADAR reflections. In a point cloud, each point may be characterized by one or more different dimensions, such as a distance, an azimuth angle, an elevation angle, a Doppler speed, a RADAR cross-section, etc., or a selection thereof. RADAR spectra may include measured RADAR signals and may comprise dimensions such as distance, Doppler speed, azimuth, and elevation, or a selection thereof.

To provide a precise representation of the environment of a device, algorithms for sensing the environment process the measurement data in the available form. For example, the algorithms may work with RADAR point clouds and/or with RADAR spectra.

A typical task of the algorithms may be, for example, detection of one or more objects and/or their classification. Objects may be cars or traffic control systems, or pedestrians or animals, etc. For example, the algorithm may provide a position, a pose, a speed, a class, and possibly additional properties of an object, or multiple detected objects, in the environment. A class may be, for example, a type of an object, such as vehicle or living being.

Another typical task may be, for example, estimating a trajectory that is available in the environment of the device, such as a drivable area in the surroundings of a car or possible trajectories of an aircraft in a mountainous area.

These tasks may be solved with deep learning methods, i.e. deep neural networks. One approach that works with object detection based on RADAR point clouds is described by Ulrich, M., Braun, S., Köhler, D., Niederlöhner, D., Faion, F., Gläser, C. and Blume, H. in “Improved Orientation Estimation and Detection with Hybrid Object Detection Networks for Automotive RADAR”, 2022 IEEE 25^{th} International Conference on Intelligent Transportation Systems (ITSC), arXiv: 2205.02111. One approach for detecting and classifying based on RADAR spectra is described by Patel, K., Rambach, K., Visentin, T., Rusev, D., Pfeiffer, M. and Yang, B. in “Deep Learning-based Object Classification on Automotive RADAR-Spectra,” 2019 IEEE RADAR-Conference (RADAR-Conf), Boston, MA, USA, 2019, pp. 1 to 6.

If an approach is based on point clouds, it uses for example RADAR point clouds as input data. As a result, information that the RADAR sensor sensed may be lost when the measured data are mapped onto the point cloud. Less information may be available to the algorithm to solve a task because mapping RADAR spectra onto RADAR point clouds is usually non-reversible.

Algorithms that use spectra such as RADAR spectra as input data are able to access more information. The use of spectra may require more computational effort than, for example, the use of point clouds because larger amounts of data must be processed. Furthermore, it may require more effort to record spectra because large amounts of data must be stored in a short time during respective measurements to record spectra. Compared to point clouds for example, storing spectra during a measurement may require a higher bandwidth, and more storage space may be required to store the measurement data.

The above applies analogously to measurements with other sensors that can provide spectra and/or point clouds, such as LIDAR or SONAR sensors.

It would, therefore, be desirable to provide a method and system that allows for rapid, precise and reliable sensing of an environment, without loss of information that would be significant for the particular application. Furthermore, a reduction in the required technical effort would be desirable to make possible a simpler and more cost-effective recording and/or processing of the measurement data.

### SUMMARY

The present invention provides a method and system for sensing an environment of a device using sparse spectra.

Preferred embodiments of the present invention are disclosed herein.

The methods, systems and device of the present invention are in particular directed toward enabling rapid, precise and reliable sensing of an environment without loss of information that would be relevant to the respective applications in, for example, the motor vehicle, aviation, marine, astronautics and/or manufacturing industries. The disclosed methods, systems, and devices may have reduced technical complexity and thus make possible a simpler and more cost-effective recording and/or processing of the measurement data.

According to a first aspect, the present invention relates to a method for sensing an environment of a device by means of sparse spectra. According to an example embodiment of the present invention, the method comprises: generating, with a sensor of the device, a time signal with information about features of an object or multiple objects in the environment of the device; determining dense spectra having N dimensions based on the time signal, wherein the time signal comprises information for generating dense spectra having K dimensions, where K is greater than or equal to N; determining sparse spectra having N dimensions based on the dense spectra having N dimensions, wherein the amount of data for representing the sparse spectra is less than the amount of data for representing the dense spectra having N dimensions; and determining first features of the one or more objects for a point or for a plurality of points in the sparse spectra.

According to a further development of the present invention, the method further comprises selecting the one or more points in the sparse spectra.

According to a further development of the present invention, the method further comprises determining first features of the one or more objects for one or more points in the sparse spectra, determining second features of the object from the dense spectra having K dimensions without the dense spectra with N dimensions according to the one or more points.

According to a further development of the present invention, the method further comprises: detecting the one or more objects in the environment of the device based on the first features; and/or detecting the one or more objects in the environment of the device based on the second features; and/or classifying the one or more objects in the environment of the device; and/or semantic segmentation of the first features and/or the second features and/or the dense spectra and/or the sparse spectra; and/or; estimating a free space in the environment of the device.

According to a further development of the present invention, K is greater than N.

According to a further development of the present invention, determining the sparse spectra having N dimensions based on the dense spectra comprises disregarding data that are less than a threshold value.

According to a further development of the present invention, determining the sparse spectra having N dimensions based on the dense spectra having N dimensions comprises disregarding data outside a respective range around a point, in particular a local maximum.

According to a further development of the present invention, a respective area around the point or the local maximum is an N-dimensional rectangle, an N-dimensional sphere, or an N-dimensional ellipsoid.

According to a further development of the present invention, determining sparse spectra having N dimensions occurs using a neural network.

According to a further development of the present invention, the sensor of the device is a RADAR sensor, a LIDAR sensor, a SONAR sensor, or an ultrasonic sensor, and/or N is equal to 2 having the dimensions of distance and speed.

According to a second aspect, the present invention relates to a system for sensing an environment of a device by means of sparse spectra. According to an example embodiment of the present invention, the system comprises: a processor; and a non-volatile computer-readable storage medium comprising instructions that, when carried out by the processor, cause the system to perform the method as described above.

According to a third aspect, the present invention relates to a device comprising the system described above; and one or more sensors that are connected to the system.

### BRIEF DESCRIPTION OF THE DRAWINGS

FIG. 1 shows an example method for sensing an environment of a device by means of sparse spectra, according to one example embodiment of the present invention.

FIG. 2 shows a schematic illustration of an example spectrum and a sparse spectrum generated therefrom, according to one example embodiment of the present invention using RADAR technology.

In all figures, identical or functionally identical elements and devices are provided with the same reference signs. The numbering of method steps is for the sake of clarity and is generally not intended to imply a specific chronological order. It is in particular also possible to carry out multiple method steps simultaneously.

### DETAILED DESCRIPTION OF EXAMPLE EMBODIMENTS

The present invention provides using sparse spectra to solve environmental sensing tasks such as object detection. The sparse spectra may, for example, be created by only taking into account data that are above a certain signal threshold. These may be, for example, all points that are above an estimated noise level. The data thus obtained may be interpreted as either sparse spectra or very dense point clouds.

Methods are provided that are able to process these data efficiently. In contrast to the methods cited above according to Ulrich et al. (2022) and Patel et al. (2019), the methods use neither full spectra nor point clouds, but rather an intermediate representation that requires less storage space than the full spectra but has a higher information content than point clouds.

Compared to methods that operate based on full spectra, the proposed methods of the present invention may have the advantages described below.

When recording measurement data, the sparse spectra may already be generated during the measurement. Thus, a bandwidth requirement to store data may be reduced compared to the requirement when using full spectra. Measurement data may, therefore, be simpler and/or more cost effective to record, or measurement data may be acquired at a higher frequency. This may be in particular advantageous for detecting objects in the environment and/or for tracking objects in real time.

Sparse spectra may include less data than full spectra. Thus, a storage space requirement to store data may be reduced compared to the requirement when using full spectra. When applying deep learning algorithms, a large data set is generally required. With the proposed invention, it is easier to provide large data sets with many measurements since less storage space is required.

When conventionally storing full spectra during a measurement, compromises may be required that result in information contained in the full spectra not being saved. During storage, one or more dimensions may not be saved. For example, in a spectrum with the dimensions distance, Doppler speed and azimuth angle, only two dimensions may be saved, e.g., distance and Doppler speed. Since the disclosed methods work with sparse spectra that require less storage space, it may be possible to store more or all dimensions as compared to conventional storage, thereby eliminating or reducing information loss.

It may also be possible that the sparse spectra have less data compared to conventional spectra, and therefore are subject to lower computing capacity requirements. The disclosed methods may result in less computational effort to detect and/or track one or more objects in the environment of a device, because less data must be processed, for example. This may be advantageous in the development of new algorithms, as a training effort for neural networks may be reduced.

The methods may also be advantageous for devices configured for autonomous operation, such as a control system in a vehicle that regularly requires cheaper hardware with less processing power, in order to succeed in the market, in particular with regard to costs of production.

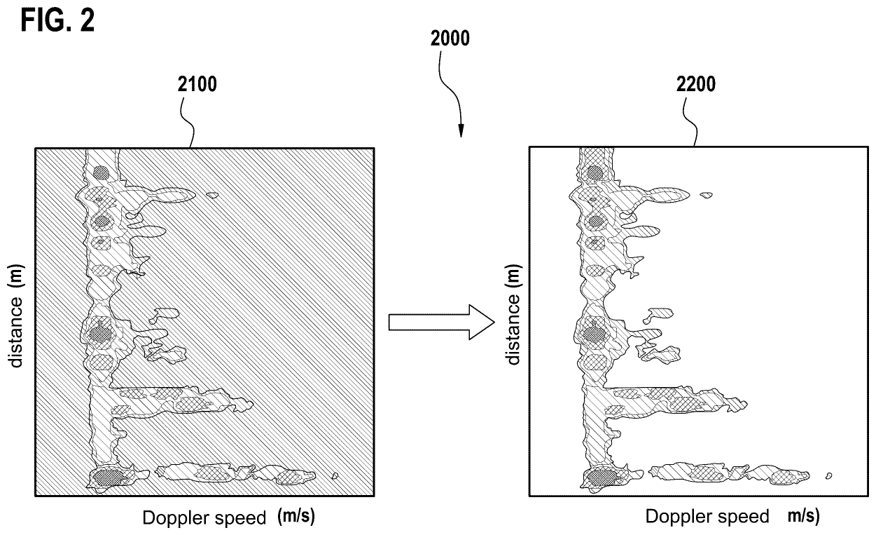

The computational effort may also be reduced compared to the use of full spectra due to the fact that, for example, after determining a sparse two-dimensional spectrum (compare, for example, FIG. 2) only for the sparse spectrum, the information is determined in one or more further dimensions, such as the azimuth angles, for example. Such a method may reduce computational effort and/or hardware costs both in development, when acquiring measurements for training the device using neural networks, as well as in the finished product.

Compared to conventional methods that work with point clouds, more information may be provided with the disclosed methods, which make possible, for example, improved detection of objects and/or improved classification of objects with a potentially higher accuracy.

The methods may be used, for example, in devices in the motor vehicle, aviation, marine, astronautics and/or manufacturing industries, in particular in connection with RADAR sensors. The methods are in particular suitable for use for object detection, such as semantic segmentation or for estimating a free space for environmental sensors, for example, in the automotive field. It is also possible to use them with other sensors and/or sensor systems, as described above.

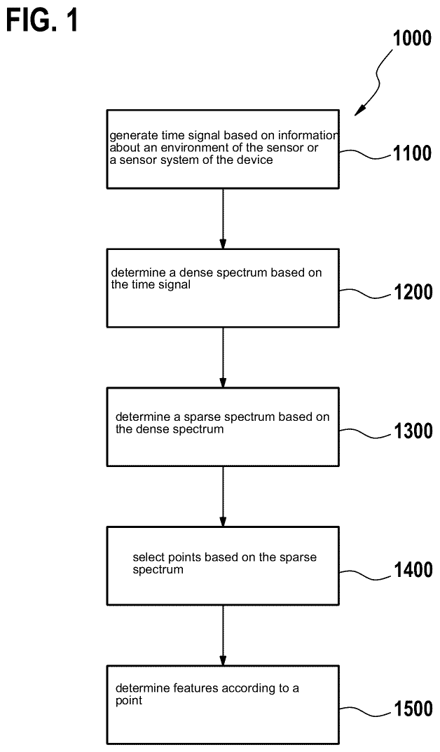

FIG. 1 shows an example method 1000 for sensing an environment of a device by means of sparse spectra, according to one embodiment. Method 1000 substantially illustrates a signal processing chain of a sensor that measures a time signal to determine spectra, from which points are extracted to detect objects.

The method comprises measuring an analog signal by means of a sensor or by means of a sensor system. The method may further comprise converting the analog signal into a digital signal. In summary, the method may include generating 1100 a time signal based on information about an environment of a sensor or a sensor system of a device. The time signal may comprise one or more signals, for example a signal for each measured channel.

A spectrum, such as a RADAR spectrum 2100, may be determined from the time signal by means of digital signal processing, e.g., Fourier transformations, as shown in FIG. 2. These are dense spectra, also referred to herein as full spectra. In other words, the method 1000 may comprise determining 1200 a dense spectrum based on the time signal.

A noise may be filtered out of the dense spectrum. This may be done, for example, with a constant false alarm rate detector (CFAR) that estimates the strength of a noise and the strength of an echo signal and only maintains the data that are above a threshold value. Data that are below the threshold value are filtered out to generate a sparse spectrum, such as the sparse spectrum 2200 in FIG. 2. In other words, the method 1000 may comprise determining 1300 a sparse spectrum based on the dense spectrum.

Features may be determined from the sparse spectrum for a selection of points, for example for local maxima, in the case of RADAR sensors, RADAR detections or RADAR reflections, or for each point of the sparse spectrum. In other words, the method 1000 may comprise selecting 1400 points based on the sparse spectrum. The method may comprise determining 1500 features according to a point, such as an azimuth angle, an elevation angle, and/or a RADAR cross-section. Each feature may correspond to one dimension of the dense and/or sparse spectrum.

As a result of determining 1500, a list may be generated with one or more features corresponding to the respective point, also referred to as a point cloud. Conventional methods of detecting objects use either the point cloud based on the dense spectra or the dense spectra as input data for a deep learning algorithm. The method may comprise determining 1500 first features according to one point in the sparse spectrum and second features according to one point in the dense spectrum.

Finally, the method 1000 may include detecting 1600 objects based on the determined first features and/or second features.

In the methods according to the present disclosure, sparse spectra are used as input data for an algorithm for sensing an environment of a device. In the following sections, examples are used to describe how sparse spectra are determined from dense spectra and which algorithms may be used to process the sparse spectra.

Sparse spectra are determined from dense spectra. The dense spectra may be of different formats. In one example, a sparse spectrum may be determined only for a portion of the input data (dimensions). The dimensions that are not yet processed may remain in the original format. In the case of a RADAR spectrum, the processed dimensions may be the distance and Doppler speed. The dense spectra may comprise these two dimensions for all (virtual) antenna channels. The dimensions of azimuth and elevation may not be determined. In other words, generating the dimension of azimuth angle and elevation angle for the full spectra may be dispensed with in step 1100, while the dimensions remain generally available.

In one example, the processed dimensions may be the distance, Doppler speed, and azimuth angle. The dense spectra may comprise these three dimensions for all (virtual) antenna channels. In other words, generating the elevation angles for the full spectra in step 1100 may be dispensed with, while the dimension remains generally available.

In one example, the processed dimensions may be the distance, Doppler speed, azimuth angle, and elevation angle.

If not all dimensions of the dense spectra are determined, the points in the sparse spectra may be determined with reduced dimensions, and the features in the remaining dimensions may be determined based on the points. This may result in reduced computational effort, both when creating the data sets and during the use of the object detection algorithm.

The sparse spectra may be calculated in a variety of ways. In one example, noise may be filtered out of the dense spectrum. This may be done, for example, with a constant false alarm rate detector (CFAR) that estimates the strength of a noise and the strength of an echo signal and only maintains the data that is above a threshold value. Data that is below the threshold value is filtered out to generate a sparse spectrum, such as the sparse spectrum 2200 in FIG. 2.

An offset may be added to the threshold value. The offset may also be zero or the offset may be negative. By selecting the size of the offset, how sparse or dense the particular sparse spectrum is may be configured. All data points that are above the threshold value plus offset are used further, while the remaining points are not used further.

In one example, points are selected in the sparse spectrum, as described above. For example, a point may be a local maximum. A region may be selected around each point. For example, if the full spectrum has two dimensions, the area may be a rectangle, a circle, or an ellipse around a point. For higher dimensions, the method is analogous: for n input dimensions, an n-dimensional rectangle (hyper-rectangle), an n-dimensional sphere, or an n-dimensional ellipsoid may be used around the point. Any points that are within these ranges may be used further. Points that are outside the ranges may be filtered out, i.e., not used further.

In one example, a neural network may be used to determine the sparse spectra from the dense spectra. The neural network may consist of a sequence of convolutional layers or fully connected layers, for example. However, other layers may also be used. This neural network may be trained in conjunction with the environmental sensing algorithm. This may have the advantage that determining the sparse spectra requires less computational effort.

The sparse spectra may be presented in various formats. In one example, the sparse spectra may be presented as a sparse matrix, wherein each point in the sparse matrix comprises multiple features. For example, this may be a three-dimensional sparse matrix, wherein the dimensions are a distance, a Doppler speed, and a number of features. The features of the points distance and Doppler speed may be azimuth, elevation, and RADAR cross-section, for example.

In one example, azimuth spectra may additionally be determined. In the example, the sparse spectrum may be represented by a four-dimensional matrix having the dimensions of distance, Doppler speed, azimuth, and number of features. The features may include, for example, distance and RADAR cross-section.

In one example, the sparse spectra may be represented in the form of a point cloud consisting of N points. Each point may comprise K features. The features may be, for example, a distance, a Doppler speed, an azimuth angle, an elevation angle, a RADAR cross-section, or other features. To determine a portion of the features, the position of the respective point in the sparse spectrum may be used. With a distance-Doppler speed spectrum (compare FIG. 2), for example, a position of the point in the spectrum may be used to determine the distance and the Doppler speed.

The algorithms described below may be used to process the sparse spectra, for example.

In one example, sparse spectra are represented in the form of a point cloud. Thus, conventional algorithms may be used to process point clouds, as described by, for example, Ulrich et al. (2022) and works cited therein.

To process sparse spectra, which are represented in the form of a sparse matrix, the sparse spectra may be filled in with zeros to create a fully filled matrix. As a result, conventional algorithms and deep learning architectures may be used to process the spectra, compare Patel et al. (2019) and the works cited therein.

In one example, the sparse spectra may be processed directly. This may have the advantage that computational time may be saved because only data that also contain information are processed.

Supervised, semi-supervised, or unsupervised approaches may be used to train neural networks. If labeled data are needed, automatic labels may be created by means of conventional methods. The measurements are taken with additional sensors such as a camera or LIDAR sensors as an addition to RADAR sensors. Labels may be automatically created by using these additional measurement data. Alternatively, labels may also be created manually.

What is claimed is:

1. A method for sensing an environment of a device using sparse spectra, the method comprising the following steps:
generating, with a sensor of the device, a time signal with information about features of one or more objects in the environment of the device;
determining dense spectra having N dimensions based on the time signal, wherein the time signal includes information for generating dense spectra having K dimensions, wherein K is greater than or equal to N;
determining parse spectra having N dimensions based on the dense spectra having N dimensions, wherein an amount of data for representing the sparse spectra is less than an amount of data for representing the dense spectra having N dimensions; and
determining first features of the one or more objects for one or more points in the sparse spectra.

2. The method according to claim 1, the method further comprising:
selecting the one or more points in the sparse spectra.

3. The method according to claim 1, wherein determining of the first features of the one or more objects for one or more points in the sparse spectra further includes determining second features of the object from the dense spectra having K dimensions without the dense spectra having N dimensions according to the one or more points.

4. The method according to claim 3 wherein the method further comprises:
detecting the one or more objects in the environment of the device based on the first features; and/or
detecting the one or more objects in the environment of the device based on the second features; and/or
classifying the one or more objects in the environment of the device; and/or
semantic segmentation of the first features and/or the second features and/or the dense spectra and/or the sparse spectra; and/or;
estimating a free space in the environment of the device.

5. The method according to claim 2, wherein K is greater than N.

6. The method according to claim 1, wherein the determining of the sparse spectra having N dimensions based on the dense spectra having N dimensions includes disregarding data that are less than a threshold value.

7. The method according to claim 1, wherein the determining of the sparse spectra having N dimensions based on the dense spectra having N dimensions includes disregarding data outside a respective range around a point or a local maximum.

8. The method according to claim 7, wherein a respective area around the point or the local maximum is an N-dimensional rectangle, or an N-dimensional sphere, or an N-dimensional ellipsoid.

9. The method according to claim 1, wherein determining sparse spectra having N dimensions occurs using a neural network.

10. The method according to claim 1, wherein: (i) the sensor of the device is a RADAR sensor, or a LIDAR sensor, or a SONAR sensor, or an ultrasonic sensor, and/or (ii) N is equal to 2 having dimensions of distance and speed.

11. A system configured to sense an environment of a device using sparse spectra, wherein the system comprises:
a processor; and
a non-volatile computer-readable storage medium on which are stored instructions for sensing an environment of a device using sparse spectra, the instructions, when executed by the system causing the system to perform the following steps:
generating, with a sensor of the device, a time signal with information about features of one or more objects in the environment of the device;
determining dense spectra having N dimensions based on the time signal, wherein the time signal includes information for generating dense spectra having K dimensions, wherein K is greater than or equal to N;
determining parse spectra having N dimensions based on the dense spectra having N dimensions, wherein an amount of data for representing the sparse spectra is less than an amount of data for representing the dense spectra having N dimensions; and
determining first features of the one or more objects for one or more points in the sparse spectra.

12. A device, comprising:
a system configured to sense an environment of the device using sparse spectra; and
one or more sensors that are connected to the system;
wherein the system includes:
a processor, and
a non-volatile computer-readable storage medium on which are stored instructions for sensing an environment of a device using sparse spectra, the instructions, when executed by the system causing the system to perform the following steps:
generating, with a sensor of the device, a time signal with information about features of one or more objects in the environment of the device,
determining dense spectra having N dimensions based on the time signal, wherein the time signal includes information for generating dense spectra having K dimensions, wherein K is greater than or equal to N,
determining parse spectra having N dimensions based on the dense spectra having N dimensions, wherein an amount of data for representing the sparse spectra is less than an amount of data for representing the dense spectra having N dimensions, and
determining first features of the one or more objects for one or more points in the sparse spectra.
